(19) United States
(12) Patent Application Publication
(10) Pub. No.: US 2025/0345782 A1
(43) Pub. Date: Nov. 13, 2025

(54) METHOD FOR PREPARING PHOSPHORUS-CONTAINING LIGAND

(71) Applicants: ZHEJIANG NHU COMPANY LTD., Shaoxing (CN); ZHEJIANG NHU SPECIAL MATERIALS CO., LTD., Shaoxing (CN); ZHEJIANG NHU NYLON MATERIALS CO., LTD., Shaoxing (CN)

(72) Inventors: Zengshi ZHA, Shaoxing (CN); Zhirong CHEN, Hangzhou (CN); Wenbin WU, Shaoxing (CN); Tinglan ZHANG, Shaoxing (CN); Hong YIN, Hangzhou (CN); Keyan WANG, Shaoxing (CN); Litao ZHOU, Shaoxing (CN); Haoran LI, Hangzhou (CN); Guodong HUANG, Shaoxing (CN); Yong XU, Shaoxing (CN)

(21) Appl. No.: 17/799,923

(22) PCT Filed: Jun. 29, 2022
(86) PCT No.: PCT/CN2022/102172

§ 371 Date: Feb. 13, 2025

(30) Foreign Application Priority Data
Apr. 26, 2022 (CN) 202210445344.8

(51) Int. Cl. B01J 31/18; C07F 9/141; C07F 9/572; C07F 9/6506; C07F 9/6584

(52) U.S. Cl. CPC B01J 31/186; B01J 31/185; C07F 9/1412; C07F 9/572; C07F 9/6506; C07F 9/6584; B01J 2531/004

(57) ABSTRACT

A method for preparing a phosphorus-containing ligand is provided, which includes: mixing a phosphorus chloride compound, polypyridine ionic liquid-loaded porous microspheres with a first organic solvent to obtain a first mixture, and mixing a compound in Formula (2) with a second organic solvent to obtain a second mixture,

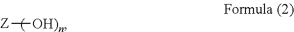

wherein Z is a multivalent aliphatic hydrocarbon group or a multivalent aromatic hydrocarbon group comprising at least one substituent group, wherein the substituent group is selected from hydrogen atom, halogen atom, C₁-C₁₀ alkyl group, C₁-C₁₀ alkoxy group, C₁-C₁₀ alkanoyl group, aryl group, heteroaryl group, cyano group, or nitro group, and n is an integer from 1 to 8; and mixing the first mixture with the second mixture to make the first mixture react with the second mixture to obtain a reaction mixture, removing generated HCl, filtrating to obtain a filter liquor, and treating the filter liquor to obtain the phosphorus-containing ligand.

### CROSS-REFERENCE TO RELATED APPLICATIONS

This application claims all benefits accruing from China Patent Application No. 202210445344.8, filed on Apr. 26, 2022, and titled “METHOD FOR PREPARING PHOSPHORUS-CONTAINING LIGAND”, in the China National Intellectual Property Administration, the content of which is hereby incorporated by reference.

### TECHNICAL FIELD

The present disclosure relates to a technical field of a phosphorus-containing ligand, in particular, to a method for preparing a phosphorus-containing ligand.

### BACKGROUND

Phosphite ester compounds are known in the art as catalytic systems associated with hydrocyanation of alkenes. In related technologies, phosphite compounds are usually prepared by purging R—OH and phosphorus chloride compounds with an inert gas or adding an organic base acid binding agent to the R-OH and the phosphorus chloride compounds.

During a process for preparing a bidentate phosphorus-containing ligand and a multidentate phosphorus-containing ligand in the related art, a liquid amine compound is normally added as an acid binding agent to react with a generated hydrogen chloride to generate an ammonium hydrochloride. After a reaction is finished, a target product is purified by filtration, removal of solvent, and column chromatography. However, the method in related art generally has problems such as a large consumption amount of acid binding agent, an excessively high viscosity of the reaction system, a difficult post-processing of the acid binding agent, and a complicated recycling procedure, which increase a cost of wastes treatment.

Therefore, how to solve problems such as a high salt content, a high viscosity and a difficult post-processing of a system after using the acid binding agent in a process for preparing phosphorus-containing ligand compounds, and how to solve problems of a low selectivity and a low conversion rate in the process for preparing phosphorus-containing ligand compounds are challenges in the art. Meanwhile, for some phosphorus-containing ligand compounds including sensitive groups (such as double bonds, etc.), it is also an urgent need in the art to prepare them by faster methods under milder conditions.

### SUMMARY

Details of one or more embodiments of the present disclosure are set forth in the following description. Other features, objects and advantages of the present disclosure will become apparent from the specification and the claims.

In some embodiments of the present disclosure, a method for preparing a phosphorus-containing ligand is provided. In the method, polypyridine ionic liquid-loaded porous microspheres are employed as catalysts and hydrogen chloride produced by the reaction are removed from a reaction device, so that the method may have an excellent reaction selectivity and an excellent yield.

A method for preparing a phosphorus-containing ligand includes the following steps:
mixing a phosphorus chloride compound as shown in Formula (1), first polypyridine ionic liquid-loaded porous microspheres with a first organic solvent to obtain a first mixture, and mixing a compound as shown in Formula (2) with a second organic solvent to obtain a second mixture; and
mixing the first mixture with the second mixture in a reaction device to make the first mixture react with the second mixture to obtain a reaction mixture, removing generated hydrogen chloride from the reaction device, filtrating the reaction mixture to obtain a filter liquor after a reaction of the first mixture and the second mixture, and treating the filter liquor to obtain the phosphorus-containing ligand,

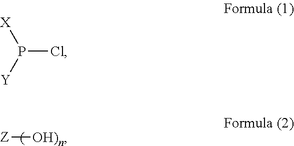

wherein in Formula (1), X and Y are independently selected from substituted aryloxy groups or nitrogen-containing heterocyclic groups,
in Formula (2), Z is a multivalent aliphatic hydrocarbon group or a multivalent aromatic hydrocarbon group including at least one substituent group,
wherein the at least one substituent group is selected from hydrogen atom, halogen atom, C₁-C₁₀ alkyl group, C₁-C₁₀ alkoxy group, C₁-C₁₀ alkanoyl group, aryl group, heteroaryl group, cyano group, or nitro group, and n is an integer in a range of 1 to 8.

In an embodiment, the first polypyridine ionic liquid-loaded porous microspheres includes a polypyridine ionic liquid, and a structural formula of the polypyridine ionic liquid is shown in Formula (3),

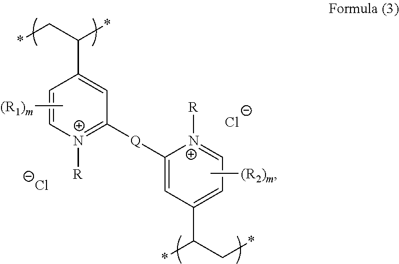

in Formula (3), R is selected from a C₁-C₁₀ linear chain alkyl group or a C₁-C₁₀ branched chain alkyl group, wherein R1 and R2 is independently selected from hydrogen atom, halogen atom, C₁-C₁₀ alkyl group, C₁-C₁₀ alkoxy group, C₁-C₁₀ alkanoyl group, aryl group, heteroaryl group, cyano group, or nitro group, m is an integer in a range of 0 to 3, and Q is a direct bond or a divalent linking group.

In an embodiment, Q is selected from

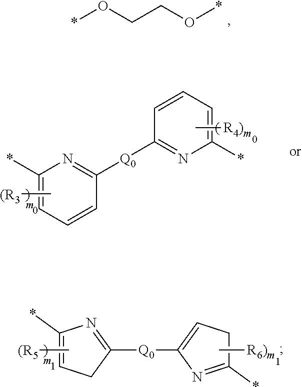

wherein R₃, R₄, R₅, and R₆ are independently selected from hydrogen atom, halogen atom, C₁-C₁₀ alkyl group, C₁-C₁₀ alkoxy group, C₁-C₁₀ alkanoyl group, aryl group, heteroaryl group, cyano group, or nitro group, wherein Q₀ is selected from a direct bond or a divalent linking group, m₀ is an integer in a range of 0 to 3, and m₁ is an integer in a range of 0 to 2.

In an embodiment, Q₀ is selected from

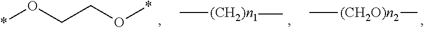

substituted aryl group, or unsubstituted aryl group, and n₁ and n₂ are independently selected from integers in a range of 1 to 50.

In an embodiment, the first polypyridine ionic liquid-loaded porous microspheres includes polystyrene porous microspheres, particle sizes of the polystyrene microspheres are in a range of 50 nm to 100 nm, and a relative deviation of the particle sizes is less than 3%.

In an embodiment, a BET specific surface area of the first polypyridine ionic liquid-loaded porous microspheres is in a range of 50 m²/g to 500 m²/g, and an average aperture size of apertures in the first polypyridine ionic liquid-loaded porous microspheres is in a range of 10 nm to 50 nm.

In an embodiment, in Formula (1), a structural formula of the substituted arylxy groups is

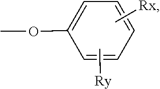

wherein Rx and Ry are independently selected from hydrogen atom, halogen atom, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

In an embodiment, when both X and Y are selected from

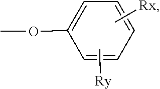

X and Y are not cyclized. In an embodiment, when both X and Y are selected from nitrogen-containing heterocyclic groups, X and Y are not cyclized, or X and Y are cyclized via a single bond or methylene. In an embodiment, when X is selected from

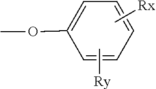

and Y is selected from nitrogen-containing heterocyclic groups, X and Y are cyclized via methylene.

In an embodiment, the nitrogen-containing heterocyclic groups are selected from

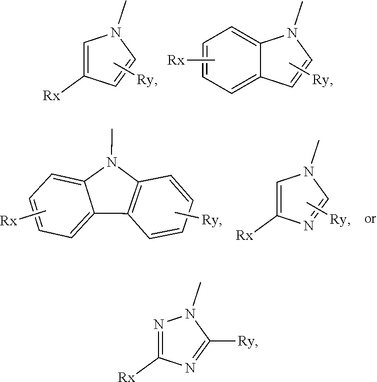

wherein Rx and Ry are independently selected from hydrogen atom, halogen atom, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

In an embodiment, both X and Y are selected from nitrogen-containing heterocyclic groups, and X and Y are cyclized via the single bond or the methylene to form a structure selected from the group consisting of

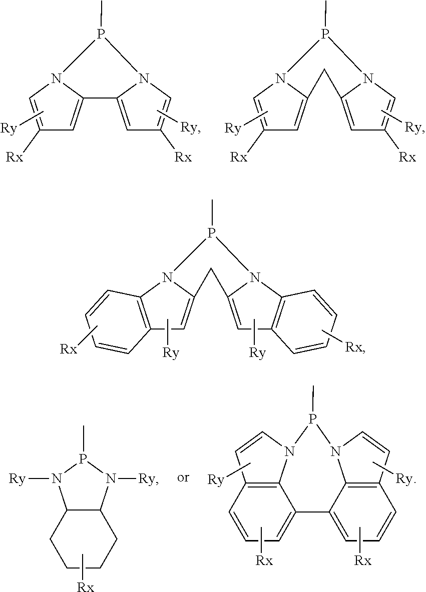

In an embodiment, in Formula (2), Z is selected from

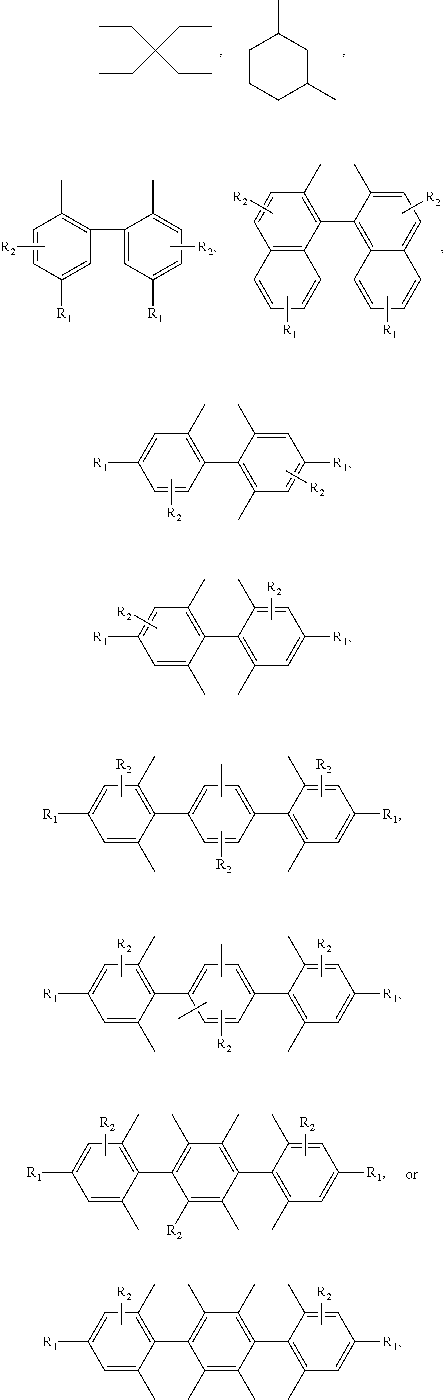

wherein R₁ and R₂ are independently selected from hydrogen atom, halogen atom, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

In an embodiment, in Formula (2), n is an integer in a range of 2 to 4.

In an embodiment, in the step of mixing the first mixture with the second mixture in the reaction device to obtain the reaction mixture, a molar ratio of the phosphorus chloride compound to the compound as shown in Formula (2) is in a range of 1.0:(1/x) to 1.3:(1/x), x is equal to n in Formula (2), and a molar ratio of nitrogen atoms in the first polypyridine ionic liquid-loaded porous microspheres to hydroxyl groups in the compound as shown in Formula (2) is in a range of 0.01:1 to 0.1:1.

In an embodiment, a molar concentration of the phosphorus chloride compound in the first mixture is in a range of 0.05 mol/L to 5.0 mol/L, and a molar concentration of the compound as shown in Formula (2) in the second mixture is in a range of 0.05 mol/L to 5.0 mol/L.

In an embodiment, in the step of mixing the first mixture with the second mixture in the reaction device to make the first mixture react with the second mixture to obtain the reaction mixture, a reaction temperature is in a range of 0 to 50 degrees centigrade, and a reaction time is in a range of 1 hour to 5 hours.

In an embodiment, in the step of mixing the first mixture with the second mixture in the reaction device to make the first mixture react with the second mixture to obtain the reaction mixture, the second mixture is added into the first mixture in batches.

In an embodiment, in the step of adding the second mixture into the first mixture in batches, an adding duration is in a range of 2 hours to 10 hours.

In an embodiment, the step of filtrating the reaction mixture to obtain the filter liquor after the reaction further includes recovering second polypyridine ionic liquid-loaded porous microspheres.

In an embodiment, after the recovering the second polypyridine ionic liquid-loaded porous microspheres, the recovered second polypyridine ionic liquid-loaded porous microspheres are washed, dried and re-used for preparing the first mixture.

In an embodiment, the step of mixing the first mixture with the second mixture in the reaction device to make the first mixture react with the second mixture to obtain the reaction mixture further includes blowing a protective gas in to the reaction device to remove the generated hydrogen chloride out from the reaction device, so as to co-produce hydrogen chloride.

### DETAILED DESCRIPTION

In Chinese patent No. CN101250200A, a synthetic method of bis(2,4-di-tert-butylphenyl) pentaerythritol diphosphate ester was provided. In the synthetic method, nitrogen gas was introduced to reactants and stirred, and hydrogen chloride generated in the reaction was absorbed by a sodium hydroxide solution. In Chinese patent No. CN106220681A, a method for preparing a phosphite ester antioxidant was provided. In the method, a slight positive pressure of a system was maintained during a reaction, and generated hydrogen chloride was completely discharged into a hydrogen chloride absorption system to generate hydrochloric acid.

In Chinese patent No. CN102875599A, a method for preparing tridentate phosphorus-containing ligands was provided. In the method, 2, 2′, 6-trihydroxybiphenyl was reacted with dipyrrole phosphorus chloride in the presence of an anhydrous triethylamine, and after a reaction was completed, a triethylamine hydrochloride was filtered, and a target product with a yield of 64% was obtained by removal of solvent, a crude purification through column chromatography and a recrystallization using methanol. Chinese patent No. CN101331144B disclosed a method for preparing a tetradentate phosphorus ligand. In the method, 2, 2′, 6, 6′-tetrahydroxy-1, 1′-biphenyl was reacted with dipyrrole phosphorus chloride in the presence of an anhydrous triethylamine, and after a reaction was completed, a target product with a yield of 36% was obtained by a filtration, a removal of solvent, and column chromatography.

Chinese patent No. CN100441584C disclosed a method for preparing a pentaerythritol phosphite ester antioxidant. In the method, pentaerythritol, a solvent, phosphorus trichloride, and 2, 6-di-tertbutyl-p-cresol were used as raw materials and a weak base type macroporous ion exchange resin was used as a catalyst to prepare pentaerythritol phosphite ester. Hydrogen chloride gas generated in a reaction was removed from a system. The catalyst after the reaction was easily separated and recovered, and may be regenerated and reused. However, using the weak base type macroporous ion exchange resin as a catalyst has disadvantages such as a high cost, a large consumption amount, and a complicated regeneration treatment. The regeneration treatment may include steps of acid washing, alkali washing, distilled water washing to neutrality, and drying, which is complicated in operation, large in energy consumption, and produces a large amount of waste water and waste salt.

In order to facilitate understanding of the present disclosure, the present disclosure will be more fully described below with reference to the relevant drawings which give the preferred embodiments of the present disclosure. However, the present disclosure may be implemented in many different forms and is not limited to the embodiments described herein. Rather, these embodiments are provided for a more thorough and complete understanding of the content of the present disclosure.

Unless otherwise defined, all technical and scientific terms used herein have the same meaning as commonly understood by one of ordinary skill in the art to which the present disclosure pertains. The terms used in the specification of the present disclosure are for the purpose of describing specific embodiments only and are not intended to limit the present disclosure.

The present disclosure provides a method for preparing a phosphorus-containing ligand, which includes the following steps:

S1, mixing a phosphorus chloride compound as shown in Formula (1), polypyridine ionic liquid-loaded porous microspheres with a first organic solvent to obtain a first mixture, and mixing a compound as shown in Formula (2) with a second organic solvent to obtain a second mixture,

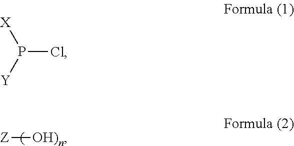

in Formula (1), X and Y are independently selected from substituted aryloxy groups or nitrogen-containing heterocyclic groups, and in Formula (2), Z is a multivalent aliphatic hydrocarbon group or a multivalent aromatic hydrocarbon group including at least one substituent group, wherein the at least one substituent group is selected from hydrogen atom, halogen atom, C₁-C₁₀ alkyl group, C₁-C₁₀ alkoxy group, C₁-C₁₀ alkanoyl group, aryl group, heteroaryl group, cyano group, or nitro group, and n is an integer in a range of 1 to 8, and

S2, mixing the first mixture with the second mixture in a reaction device to make the first mixture react with the second mixture to obtain a reaction mixture, removing generated hydrogen chloride from the reaction device, filtrating the reaction mixture to obtain a filter liquor after a reaction of the first mixture and the second mixture, and treating the filter liquor to obtain the phosphorus-containing ligand.

It should be noted that the polypyridine ionic liquid-loaded porous microspheres may include polystyrene porous microspheres and polypyridine ionic liquid loaded on the polystyrene porous microspheres. When preparing the polypyridine ionic liquid-loaded porous microspheres, the polystyrene porous microspheres can play a role of “seed crystal”. Specifically, pyridine monomers are physically adsorbed on the polystyrene porous microspheres, and polymerized to grow into a polypyridine ionic liquid by pores of the polystyrene porous microspheres. Thus, the formed polypyridine ionic liquid-loaded porous microspheres may have more active sites.

Therefore, in the present disclosure, when polypyridine ionic liquid-loaded porous microspheres are used as catalysts, the more active sites of the polypyridine ionic liquid-loaded porous microspheres can effectively improve reaction selectivity and yield. Meanwhile, because the polypyridine ionic liquid-loaded porous microspheres are in sphere-shaped, a post-processing thereof is simple, and properties of the polypyridine ionic liquid-loaded porous microspheres are more stable, a cycle performance of the polypyridine ionic liquid-loaded porous microspheres is good, thus the polypyridine ionic liquid-loaded porous microspheres are easy to be recycled and reused.

In an embodiment, a structural formula of the polypyridine ionic liquid is shown in Formula (3),

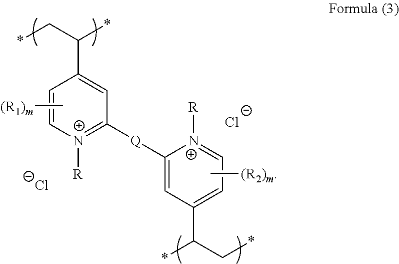

In Formula (3), R is selected from a C₁-C₁₀ linear chain alkyl group or a C₁-C₁₀ branched chain alkyl group.

In Formula (3), R₁ and R₂ are independently selected from hydrogen atom, halogen atom, C₁-C₁₀ alkyl group, C₁-C₁₀ alkoxy group, C₁-C₁₀ alkanoyl group, aryl group, heteroaryl group, cyano group, or nitro group, and m is an integer in a range of 0 to 3. In some embodiments, R₁ and R₂ are each independently selected from hydrogen atom, fluorine atom, chlorine atom, bromine atom, methyl group, ethyl group, n-propyl group, isopropyl group, methoxy group, ethoxy group, n-propyl oxy group, isopropoxy group, cyano group, acetyl group, or propionyl group.

In Formula (3), Q is a direct bond or a divalent linking group. In some embodiments, Q is selected from

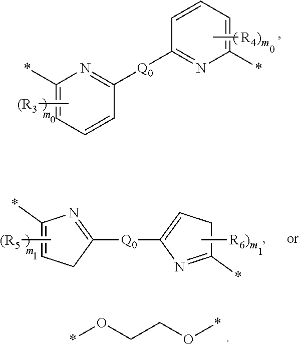

In the present disclosure, a direct bond means that two adjacent groups are directly bonded.

In some embodiments, R₃, R₄, R₅, and R₆ are independently selected from hydrogen atom, halogen atom, C₁-C₁₀ alkyl group, C₁-C₁₀ alkoxy group, C₁-C₁₀ alkanoyl group, aryl group, heteroaryl group, cyano group, or nitro group, where mo is an integer in a range of 0 to 3, and m₁ is an integer in a range of 0 to 2. In some embodiments, R₃, R₄, R₅, and R₆ are independently selected from hydrogen atom, fluorine atom, chlorine atom, bromine atom, methyl group, ethyl group, n-propyl group, isopropyl group, methoxy group, an ethoxy group, n-propoxy group, isopropoxy group, cyano group, acetyl group, or propionyl group.

In some embodiments, Q₀ is selected from a direct bond or a divalent linking group. In some embodiments, Q₀ is selected from

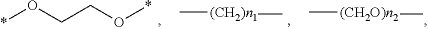

a substituted aryl group or an unsubstituted aryl group, and n₁ and n₂ are independently selected from integers in a range of 1 to 50.

In some embodiments, the polypyridine ionic liquid-loaded porous microspheres may include polystyrene porous microspheres. Particle sizes of the polystyrene porous microspheres are in a range of 50 nm to 100 nm, and a relative deviation of the particle sizes is less than 3%.

In some embodiments, the polypyridine ionic liquid-loaded porous microspheres may have a porous structure. A BET specific surface area of the polypyridine ionic liquid-loaded porous microspheres is in a range of 50 m²/g to 500 m²/g, and an average aperture size of apertures thereof is in a range of 10 nm to 50 nm.

In some embodiments, a method for preparing the polypyridine ionic liquid-loaded porous microspheres can include the following steps.
(1) Polystyrene porous microspheres are added and ultrasonically dispersed in a first surfactant aqueous solution to obtain a first emulsion; and a third organic solvent is added and ultrasonically dispersed in a second surfactant aqueous solution to obtain a second emulsion. The second emulsion is quickly added into the first emulsion and shaken and mixed for a period of time to obtain a first mixed solution containing polystyrene porous microspheres.
(2) Pyridine monomers and an initiator are dissolved in a fourth organic solvent, and then dispersed in a third surfactant aqueous solution and subjected to ultrasonic emulsification. After the ultrasonic emulsification, the resultant is quickly added to the first mixed solution, and is continuously shaken and mixed to obtain a second mixed solution.
(3) An air in the second mixed liquid is removed by displacing the air with an inert gas, and then a polymerization reaction is carried out. After the polymerization reaction is finished, a first solid is separated from a polymerization reaction liquid, washed with a fifth organic solvent, and then dried under a vacuum condition to obtain cross-linked polystyrene pyridine porous microspheres.
(4) The cross-linked polystyrene pyridine porous microspheres are mixed with a sixth organic solvent and halogenated alkanes, and then a mixture thus obtained is stirred at a certain temperature for a reaction. After the reaction is finished, a second solid is separated from a reaction liquid and washed with a seventh organic solvent, and then dried to obtain polypyridine ionic liquid-loaded porous microspheres.

In step (1) and step (2), concentrations of the first surfactant aqueous solution, the second surfactant aqueous solution and the third surfactant aqueous solution are in arrange of 0.2 wt % to 1.5 wt %. In some embodiments, concentrations of the first surfactant aqueous solution, second surfactant aqueous solution and third surfactant aqueous solution are in arrange of 0.5 wt % to 1.0 wt %. In some embodiments, a time of shaking and mixing is in a range of 6 hours to 18 hours. In some embodiments, the time of shaking and mixing is in a range of 10 hours to 12 hours.

The surfactant is selected from the group consisting of a cationic surfactant, an anionic surfactant, a nonionic surfactant, or a combination thereof. In some embodiments, the surfactant is selected from the group consisting of cetyltrimethyl ammonium bromide, benzyldimethyl octadecyl ammonium chloride, ammonium dodecyl sulfate, sodium dodecyl sulfate, sodium dodecyl benzene sulfonate, potassium dodecyl phosphate, polyvinyl alcohol, Tween-80, or a combination thereof.

In the first emulsion of step (1), a ratio of a mass of the polystyrene porous microspheres to a volume of the first surfactant aqueous solution is in a range of 1 g:20 mL to 1 g:100 mL. In the second emulsion of step (1), a volume ratio of the third organic solvent to the second surfactant aqueous solution is in a range of 1:10-1:30.

In some embodiments, the third organic solvent is selected the group consisting of ethyl acetate, tetrahydrofuran, N, N-dimethylformamide, dimethyl sulfoxide, methanol, ethanol, propanol, tert-butyl alcohol, ethylene glycol, propylene glycol, glycerol, acetone, and any combinations thereof.

In step (2), a molar ratio of the pyridine monomers to the initiator is in a range of 20:1 to 50:1, and a mass ratio of the pyridine monomers to the polystyrene porous microspheres in step (1) is in a range of 50:1 to 100:1.

In some embodiments, a general formula of the pyridine monomers is

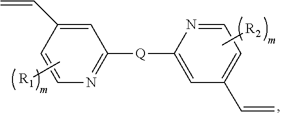

and the initiator is selected from azo initiators. In some embodiments, the initiator is at least one selected from azobisisobutyronitrile (AIBN), 2, 2′-Azobis (2,4-dimethyl)valeronitrile (ABVN), dimethyl azobisisobutyrate (AIBME), azobisisobutyronitrile amidine hydrochloride (AIBA), or azobisisobutylimidazoline hydrochloride (AIBI). The fourth organic solvent is at least one selected from aliphatic hydrocarbon or alicyclic hydrocarbon, halogenated aliphatic hydrocarbon or halogenated alicyclic hydrocarbon, substituted aromatic hydrocarbon or unsubstituted aromatic hydrocarbon, aliphatic ether, of cyclic ether. In some embodiments, the fourth organic solvent is at least one selected from benzene, toluene, xylene, dichloromethane, cyclohexane, n-hexane, or tetrahydrofuran.

In step (3), a temperature of the polymerization reaction is in a range of 40 degrees centigrade to 120 degrees centigrade. In some embodiments, the temperature of the polymerization reaction is in a range of 60 degrees centigrade to 80 degrees centigrade, and a time of the polymerization reaction is in a range of 6 hours to 36 hours. In some embodiments, the time of the polymerization reaction is in a range of 20 hours to 24 hours.

In step (3), the fifth organic solvent is at least one selected from ethyl acetate, tetrahydrofuran, N, N-dimethylformamide, dimethyl sulfoxide, methanol, ethanol, propanol, tert-butyl alcohol, ethylene glycol, propylene glycol, glycerol, or acetone.

A content of nitrogen element (ω_{N}) of the cross-linked polystyrene pyridine porous microspheres obtained in step (3) is in a range of 5% to 20%.

In step (4), a molar amount of nitrogen element (n_{N}) in the cross-linked polystyrene pyridine porous microspheres obtained in the step (3) conforms to a following equation: n_{N}=m_{C}*ω_{N}/14, wherein m_{C} refers to a mass of the cross-linked polystyrene pyridine porous microspheres. In some embodiments, a molar ratio of the cross-linked polystyrene-pyridine porous microspheres to the halogenated alkane (n_{N}:n_{halogenated alkane}) is in a range of 1:1.0 to 1:1.5.

In step (4), the sixth organic solvent is at least one selected from toluene, benzene, xylene, tetrahydrofuran, cyclohexane, n-hexane, or dichloromethane. The halogenated alkane is selected from C₁-C₁₀ halogenated alkanes. In some embodiments, the halogenated alkane is at least one selected from 1-chloropropane, 2-chloropropane, 1-bromopropane, 1-bromobutane, 2-bromobutane, 1-iodopentane, or 2-iodopentane. In some embodiments, the seventh organic solvent is at least one selected from ethyl acetate, tetrahydrofuran, N, N-dimethylformamide, dimethyl sulfoxide, methanol, ethanol, propanol, tert-butyl alcohol, ethylene glycol, propylene glycol, glycerol, or acetone.

In step (4), a reaction temperature is in a range of 60 degrees centigrade to 150 degrees centigrade. In some embodiments, the reaction temperature is in a range of 80 degrees centigrade to 120 degrees centigrade. In some embodiments, a reaction time is in a range of 6 hours to 36 hours. In some embodiments, the reaction time is in a range of 18 hours to 24 hours.

In order to obtain different phosphorus-containing ligand, in some embodiments, in phosphorus chloride compounds having a structural formula as shown in Formula (1), X and Y are independently selected from substituted aryloxy groups or nitrogen-containing heterocyclic groups.

In some embodiments, a structural formula of the substituted aryloxy group is

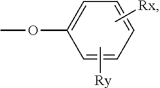

Rx and Ry are independently selected from hydrogen atom, halogen atom, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

In some embodiments, the nitrogen-containing heterocyclic group is selected from

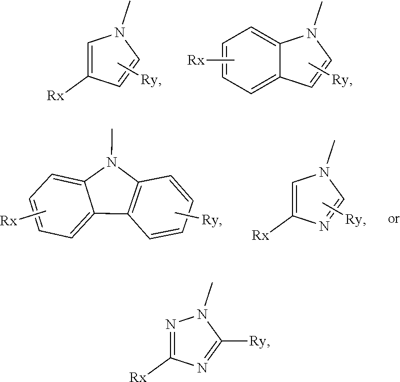

wherein Rx and Ry are independently selected from hydrogen atom, halogen atoms, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

In some embodiments, when both X and Y are each selected from

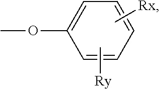

X and Y are not cyclized; when X and Y are each selected from nitrogen-containing heterocyclic groups, X and Y are not cyclized, or X and Y are cyclized via a single bond or methylene; optionally, when X is selected from

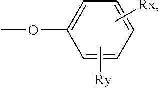

and Y is selected from a nitrogen-containing heterocyclic group, X and Y are cyclized via methylene.

In some embodiments, when both X and Y are each selected from nitrogen-containing heterocyclic groups, and X and Y are cyclized via a single bond or methylene to form a structure selected from any one of the group consisting of:

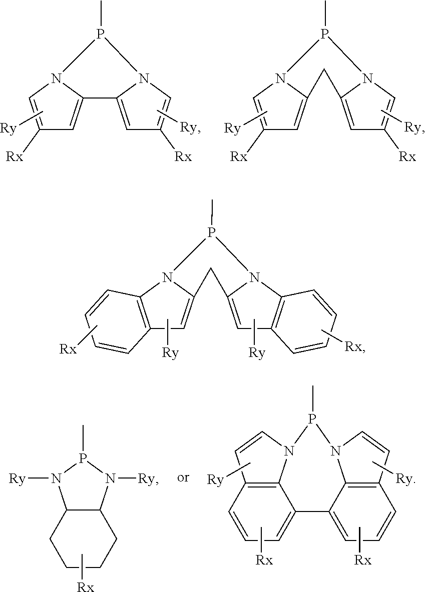

In some embodiments, in Formula (2), Z is selected from

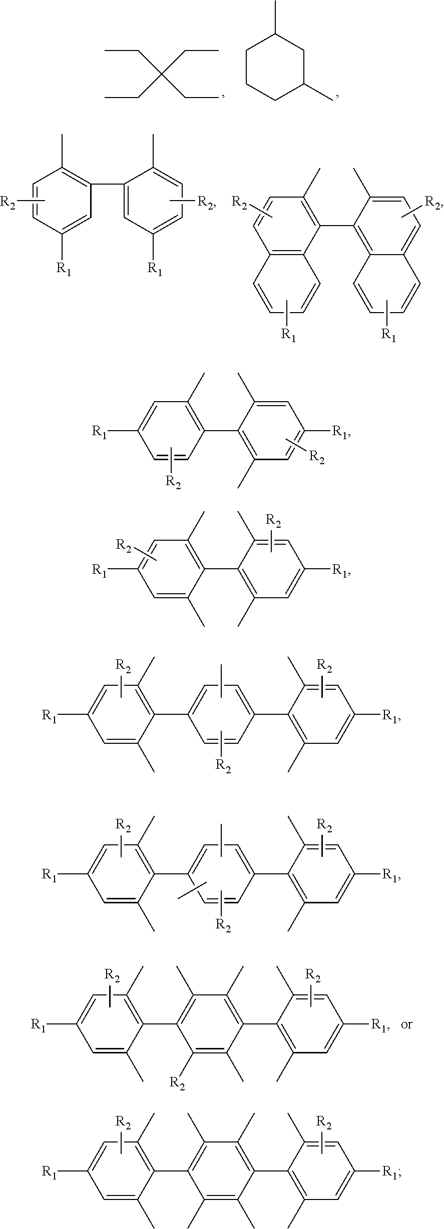

wherein R₁ and R₂ are independently selected from hydrogen atom, halogen atoms, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

In some embodiments, in Formula (2), n is an integer in a range of 2 to 8. In some embodiments, in Formula (2), n is an integer in a range of 2 to 4.

In some embodiments, both the first organic solvent in the first mixture and the second organic solvent in the second mixture are selected from at least one of C₃-C₈ alkane, ester, ether, C₃-C₆ ketone, or nitrile. In some embodiments, both the first organic solvent in the first mixture and the second organic solvent in the second mixture are selected from at least one of benzene, toluene, xylene, pentane, n-hexane, n-heptane, cyclohexane, methylcyclohexane, ether, diisopropyl ether, methyl tert-butyl ether, tetrahydrofuran, dichloromethane, 1,4-dioxane, 1,3-dioxolane, ethyl acetate, isobutyl acetate, tert-butyl acetate, acetone, 2-butanone, 3,3-dimethyl-2-butanone, benzonitrile, propionitrile, or acetonitrile. And in some embodiments, both the first organic solvent in the first mixture and the second organic solvent in the second mixture are elected from at least one of tetrahydrofuran, toluene, or ethyl acetate.

In some embodiments, a molar concentration of the phosphorus chloride compound in the first mixture is in a range of 0.05 mol/L to 5.0 mol/L. In some embodiments, a molar concentration of the phosphorus chloride compound in the first mixture is in a range of 0.05 mol/L to 2.0 mol/L.

In some embodiments, a molar concentration of the compound as shown in Formula (2) of the second mixture is in a range of 0.05 mol/L to 5.0 mol/L. In some embodiments, a molar concentration of the compound as shown in Formula (2) in the second mixture is in a range of 0.2 mol/L to 1.5 mol/L.

In step S2, in the step of mixing the first mixture with the second mixture in a reaction device to make the first mixture react with the second mixture to obtain a reaction mixture, a reaction temperature is in a range of 0 to 50 degrees centigrade. In some embodiments, the reaction temperature is in a range of 20 degrees centigrade to 30 degrees centigrade. In step S2, a reaction time is in a range of 1 hour to 5 hours. In some embodiments, the reaction time is in a range of 3 hours to 3.5 hours. Meanwhile, a molar ratio of the phosphorus chloride compound to the compound as shown in Formula (2) is controlled to be in a range of 1.0:(1/x) to 1.3:(1/x), wherein x is equal to n in the compound of Formula (2), and a molar ratio of nitrogen element in the polypyridine ionic liquid-loaded porous microspheres to a hydroxyl group in the compound as shown in Formula (2) is controlled to be in a range of 0.01:1 to 0.1:1. In some embodiments, the molar ratio of nitrogen element in the polypyridine ionic liquid-loaded porous microspheres to the hydroxyl group in the compound as shown in Formula (2) is controlled to be in a range of 0.02:1 to 0.05:1.

In some embodiments, in the step of mixing the first mixture with the second mixture in the reaction device to make the first mixture react with the second mixture to obtain the reaction mixture, the second mixture is added to the first mixture in batches by means of dropwise addition and the like. In some embodiments, the second mixture is continuously and uniformly added dropwise to the first mixture, and an adding duration is controlled in a range of 2 hours to 10 hours. And in some embodiments, the adding duration is in a range of 3 hours to 5 hours.

In step S2 of the present disclosure, in a reaction process, hydrogen chloride generated by the reaction is further removed from a reaction device, so as to solve problems of a high viscosity of a system and a difficult post-processing, while improving a selectivity of the reaction and a yield of the reaction.

In some embodiments, the generated hydrogen chloride may be removed from the reaction device by physical methods such as protective gas purging, decompression, ultrasound, etc., and discharged into a hydrogen chloride absorption system to generate hydrochloric acid.

Continuously introducing the protective gas into the reaction device and purging can improve a mixing effect of the reaction. In some embodiments, in step S2, in a step of mixing the first mixture with the second mixture in the reaction device to make the first mixture react with the second mixture, a protective gas is introduced into the reaction device for purging to remove the hydrogen chloride produced by a reaction of the first mixture and the second mixture out from the reaction device.

It can be understood that, any gas that does not affect the reaction can be used as a protective gas. In some embodiments, the protective gas is selected from at least one of nitrogen, argon, neon, helium, carbon monoxide, or carbon dioxide.

In an actual operation, a dry protective gas may be continuously introduced into the reaction device to replace the air and water vapor inside the reaction device, and then the first mixture may be added in the reaction device. Then the second mixture may be dropwise added in the reaction device, and then the second mixture may be added to the first mixture in batches by means of dropwise addition and the like. During the addition, the dry protective gas may be continuously introduced in the reaction device for purging.

After a reaction is completed, a reaction solution is filtered, a filter liquor is firstly concentrated to remove the organic solvent, and a concentrated solution is subjected to a post-treatment, separation and purification to obtain phosphorus-containing ligands. Typically, the phosphorus-containing ligands can be separated and purified by post-processing means such as column chromatography, simulated moving bed, crystallization, extraction, rectification, and the like.

Meanwhile, in a step of filtering the reaction solution, second polypyridine ionic liquid-loaded porous microspheres may be further recovered. In some embodiments, the recovered second polypyridine ionic liquid-loaded porous microspheres may be recycled and re-used in the first mixture in step S1 after washing and drying.

Hereinafter, a method for preparing the phosphorus-containing ligand will be further illustrated in conjunction with the following specific embodiments.

In the following methods for preparing polypyridine ionic liquid-loaded porous microspheres, structural formulas of pyridine monomers are as shown in Formulas N₀-1 to N₀-10.

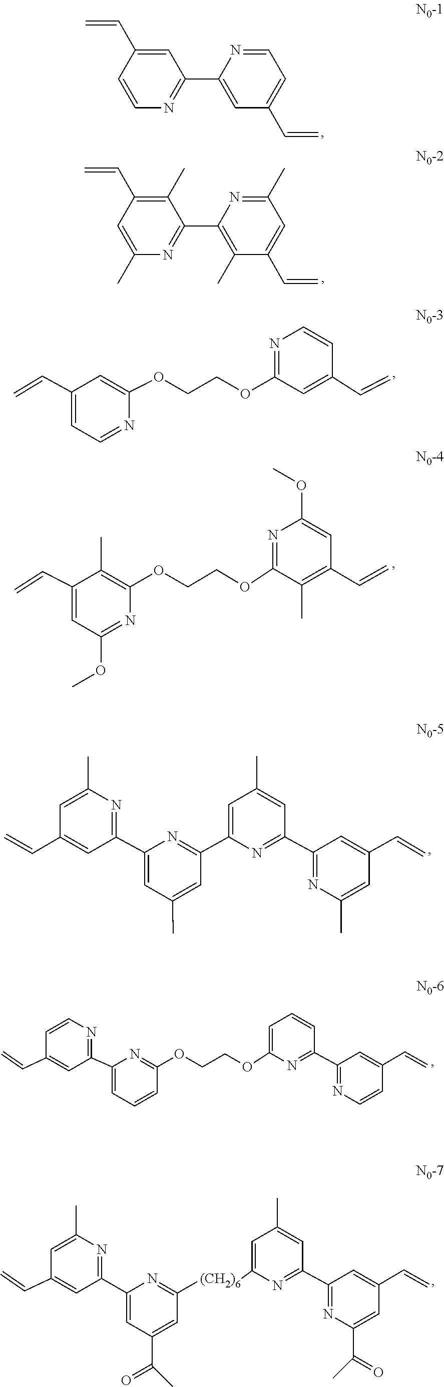

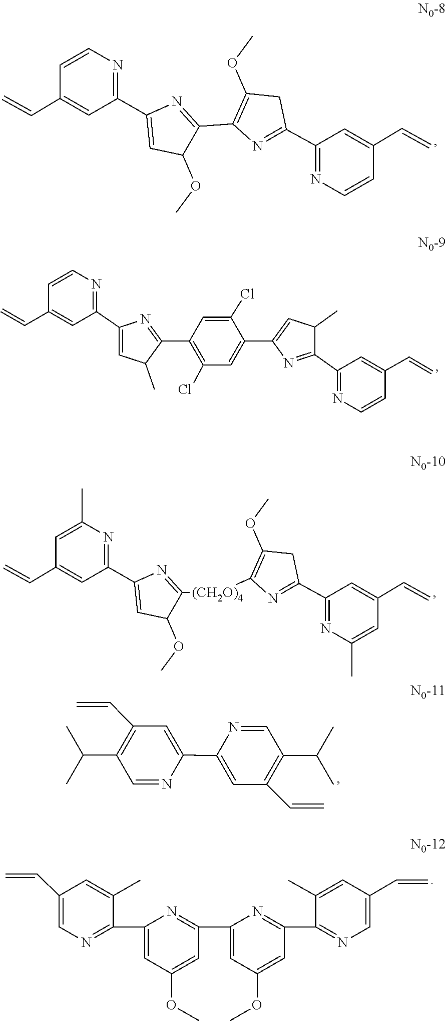

### Preparation of Polypyridine Ionic Liquid-Loaded Porous Microspheres D1

(1) 1 g of polystyrene porous microspheres (a particle size of which was 55 nm, a relative deviation of the particle sizes was 1.6%) were ultrasonically dispersed in 20 mL of a sodium dodecyl sulfate solution (0.5 wt %) to obtain a first emulsion. 2 mL of butyl acetate was ultrasonically dispersed in 20 mL of sodium dodecyl sulfate solution (0.5 wt %) to obtain a second emulsion. The second emulsion was quickly added into the first emulsion, mixed and shaken at room temperature for 12 hours to obtain a first mixed solution containing polystyrene porous microspheres.
(2) 50 g of bipyridine monomers having a structural formula as shown in Formula N₀-1 and 1.97 g of AIBN initiator were dissolved in 40 mL of toluene, and a mixture of the bipyridine monomer and the AIBN initiator were dispersed in a sodium dodecyl sulfate solution (0.5wt %) and ultrasonically emulsified. After the ultrasonic emulsification, the resultant was quickly added to the first mixed solution and mixed with the first mixed solution by continuously shaking at a room temperature for 12 hours to obtain a second mixed solution.
(3) Nitrogen was introduced into the reaction device to remove air in the second mixed solution, and the second mixed solution was then vibrated and polymerized at a temperature of 65 degrees centigrade for 24 hours. After the vibration polymerization, a polymerization reaction solution was centrifuged, washed with ethanol, and then vacuum-dried at a room temperature to obtain 49.98 g of cross-linked polystyrene pyridine porous microspheres C1. A content of nitrogen element in the cross-linked polystyrene pyridine porous microspheres C1 was tested by elemental analysis.
(4) 45 g of the cross-linked polystyrene pyridine porous microspheres were placed in a reaction flask, and then a certain amount of toluene and 34.94 g of 1-chloropropane were added into the reaction flask. The cross-linked polystyrene pyridine porous microspheres, the toluene, and the 1-chloropropane in the reaction flask were mixed evenly, and then were stirred at 100 degrees centigrade for 24 hours for a reaction. Thereafter, a reaction solution was centrifuged, washed with ethanol, and dried under vacuum at a room temperature to obtain 78.9 g of polypyridine ionic liquid-loaded porous microspheres D1 with a yield of 98.7%. A nitrogen content of the polypyridine ionic liquid-loaded porous microspheres D1 was tested by elemental analysis.

Methods for preparing polypyridine ionic liquid-loaded porous microspheres D2 to D12 were substantially the same as the method for preparing the polypyridine ionic liquid-loaded porous microspheres D1, except that some reaction parameters in the methods for preparing the polypyridine ionic liquid-loaded porous microspheres D2 to D12 are different from those in the method for preparing the polypyridine ionic liquid-loaded porous microspheres D1. Specific reaction parameters in the methods for preparing the polypyridine ionic liquid-loaded porous microspheres D2 to D12 are shown in Table 1, and reaction results thereof are shown in Table 2.

TABLE 1

| | | | | Polymerization | | | | |
|---|---|---|---|---|---|---|---|---|
| | | Pyridine monomer | | temperature/ | Initiator | | Halogenated alkane | |
| No. | Surfactant | Structure | Mass/g | degrees centigrade | Type | Mass/g | Type | Mass/g |
| D2 | Sodium dodecyl sulfate | N₀-2 | 50 | 65 | ABVN | 2.35 | 1-chloropropane | 48.02 |
| D3 | Polyvinyl alcohol | N₀-3 | 50 | 70 | AIBME | 2.15 | 1-chlorobutane | 30.99 |
| D4 | Polyvinyl alcohol | N₀-4 | 55 | 70 | AIBA | 1.67 | 2-chloropropane | 37.28 |
| D5 | Tween-80 | N₀-5 | 60 | 80 | AIBI | 1.54 | 2-chloropentane | 85.19 |
| D6 | Tween-80 | N₀-6 | 60 | 80 | AIBN | 0.78 | 2-chlorobutane | 119.58 |
| D7 | Sodium dodecyl benzene | N₀-7 | 100 | 80 | ABVN | 0.89 | 1-chloropentane | 62.77 |
| | sulfonate | | | | | | | |
| D8 | Sodium dodecyl benzene | N₀-8 | 80 | 85 | AIBN | 0.68 | 1-chloropropane | 101.53 |
| | sulfonate | | | | | | | |
| D9 | Sodium dodecyl sulfate | N₀-9 | 80 | 65 | ABVN | 0.97 | 1-chlorobutane | 131.50 |
| D10 | Polyvinyl alcohol | N₀-10 | 100 | 65 | AIBME | 0.84 | 2-chlorohexane | 64.16 |
| D11 | Tween-80 | N₀-11 | 50 | 65 | AIBA | 2.32 | 2-chlorobutane | 58.83 |
| D12 | Sodium dodecyl benzene | N₀-12 | 60 | 80 | AIBN | 0.73 | 1-chloropropane | 37.83 |
| | sulfonate | | | | | | | |

TABLE 2

| Cross-linked polystyrene | | Polypyridine ionic liquid-loaded | | | | |
|---|---|---|---|---|---|---|
| pyridine porous | | porous microspheres | | | | |
| microspheres | | | | Specific | Average | Average |
| | Content of | | Content of | surface | particle | aperture |
| | nitrogen | | nitrogen | area/ | size/ | size/ |
| No. | element/% | No. | element/% | m²/g | μm | nm |
| C1 | 13.19 | D1 | 7.43 | 394 | 580 | 28.2 |
| C2 | 10.39 | D2 | 5.03 | 404 | 562 | 32.0 |
| C3 | 10.24 | D3 | 6.06 | 412 | 554 | 30.3 |
| C4 | 7.72 | D4 | 4.42 | 388 | 548 | 29.8 |
| C5 | 13.20 | D5 | 5.18 | 379 | 532 | 28.7 |
| C6 | 13.08 | D6 | 4.12 | 410 | 541 | 29.5 |
| C7 | 9.95 | D7 | 5.86 | 422 | 553 | 31.1 |
| C8 | 13.92 | D8 | 7.01 | 418 | 567 | 30.8 |
| C9 | 10.85 | D9 | 3.77 | 412 | 570 | 31.5 |
| C10 | 10.17 | D10 | 5.94 | 420 | 558 | 32.2 |
| C11 | 18.84 | D11 | 8.17 | 385 | 558 | 29.3 |
| C12 | 12.27 | D12 | 6.98 | 392 | 564 | 30.6 |

In the methods for preparing the phosphorus-containing ligands of the following Embodiment 1 to Embodiment 12, structural formula of the phosphorus chloride compounds represented by Formula (1) are shown in Formulas E1 to E12, structural formulas of the compound represented by Formula (2) were shown as Formulas F1 to F12, and structural formulas of the phosphorus-containing ligands are as shown in Formulas L1 to L 12.

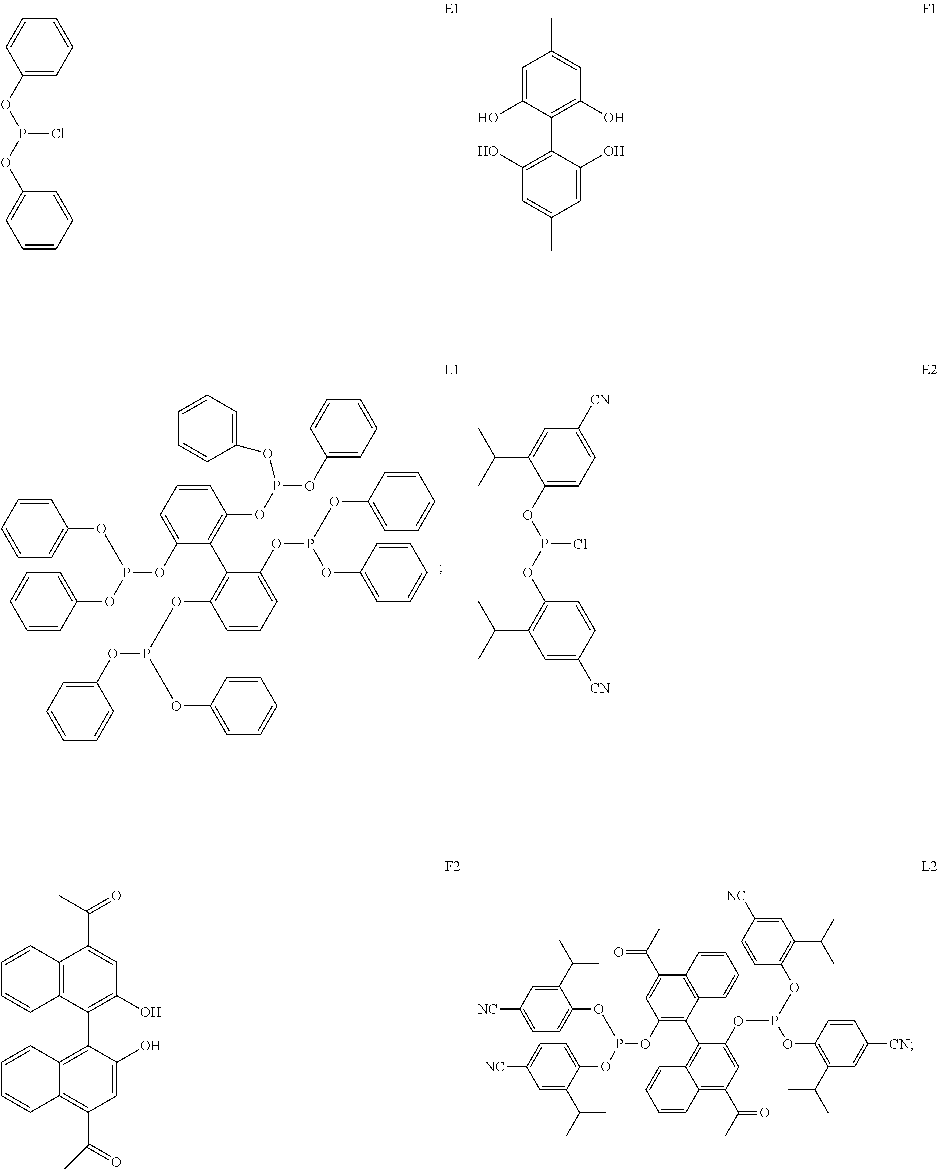

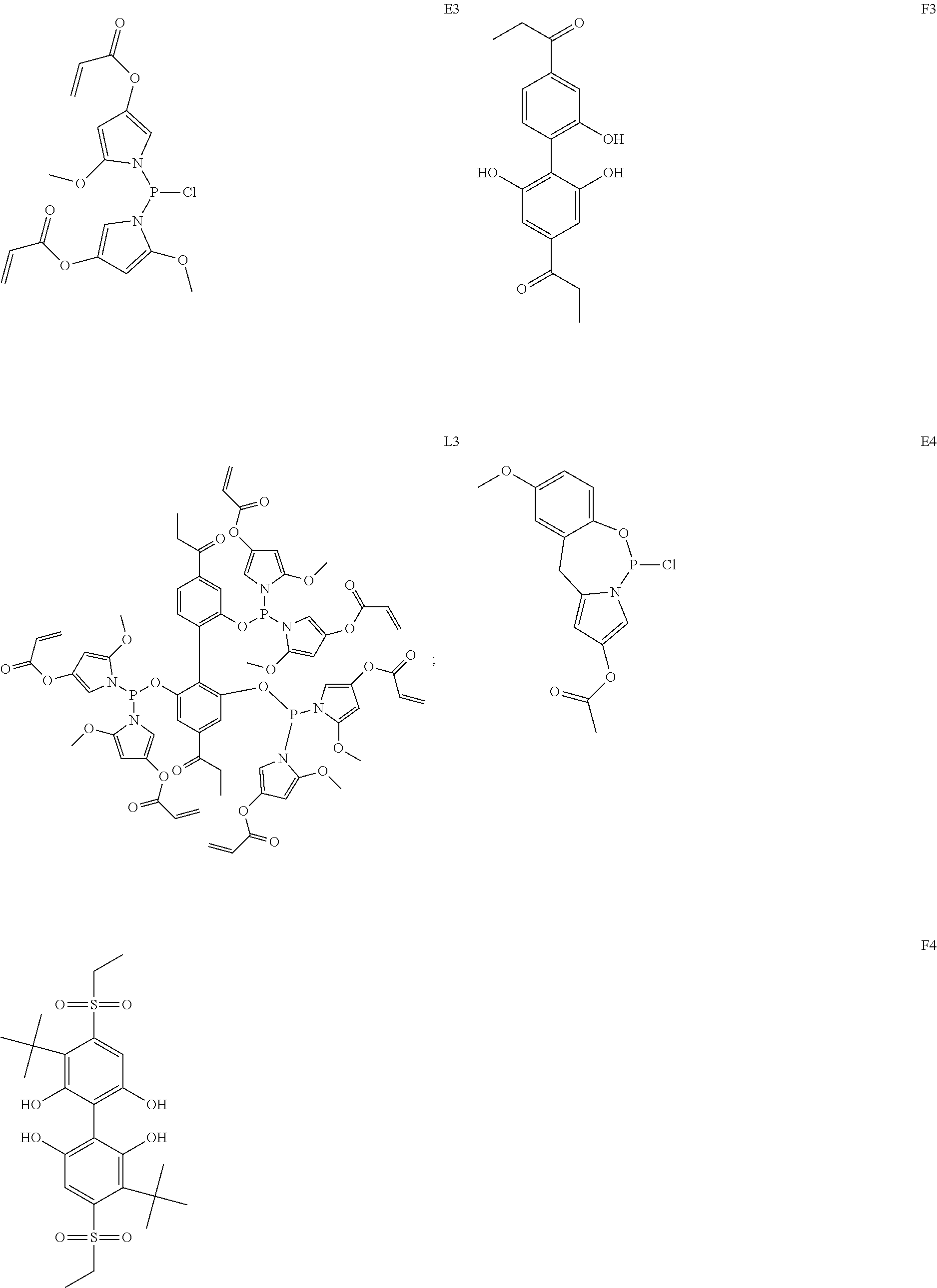

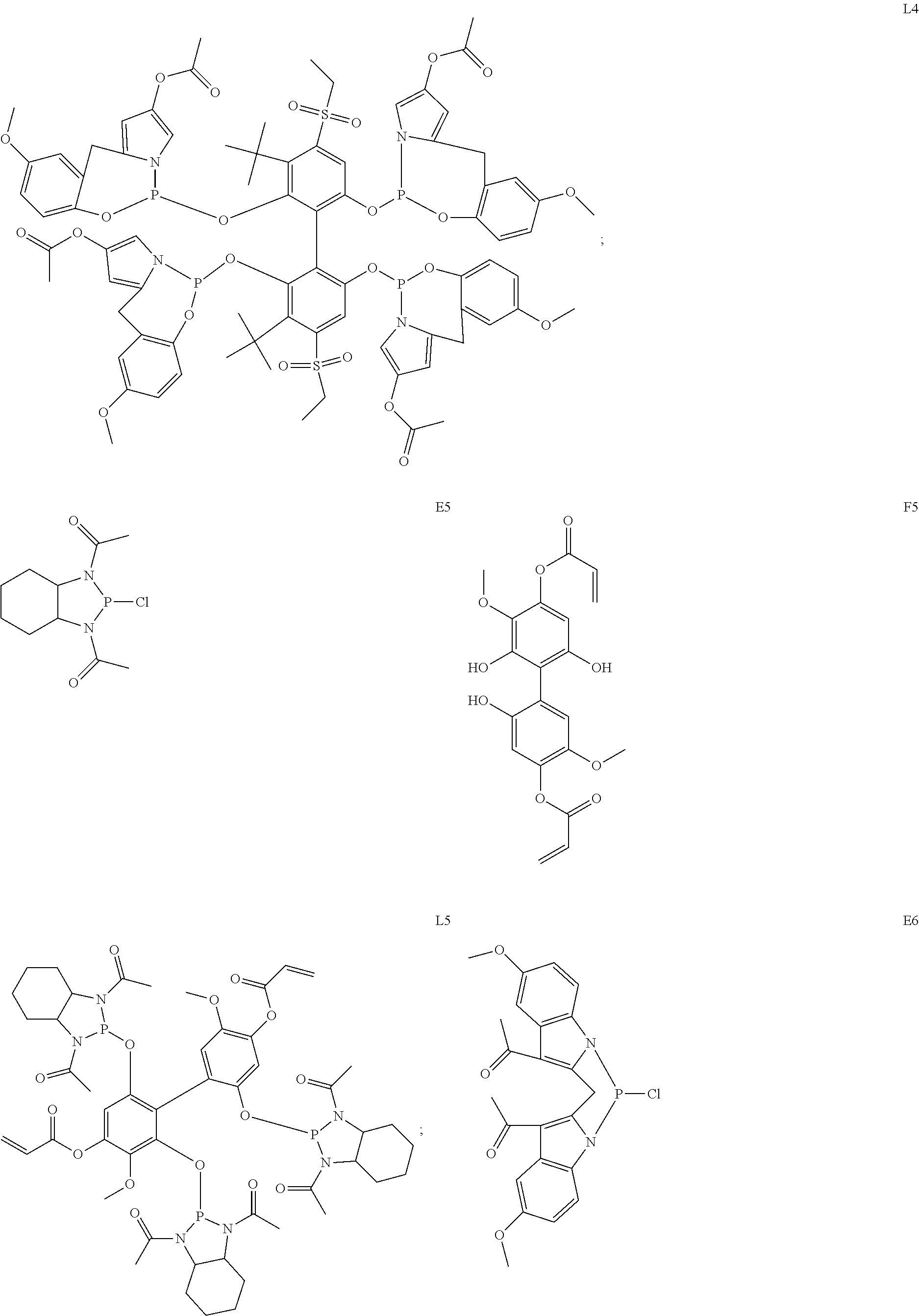

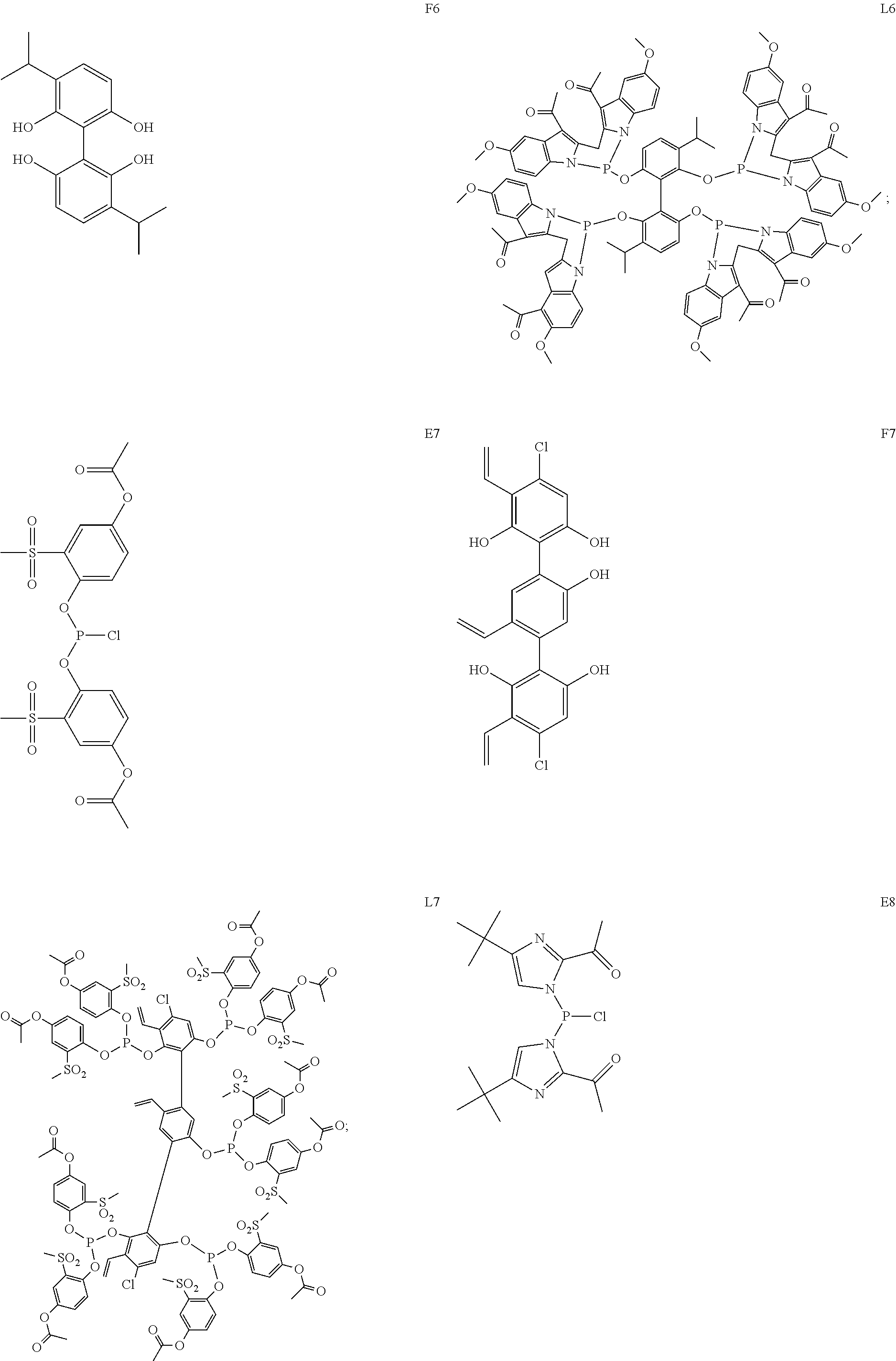

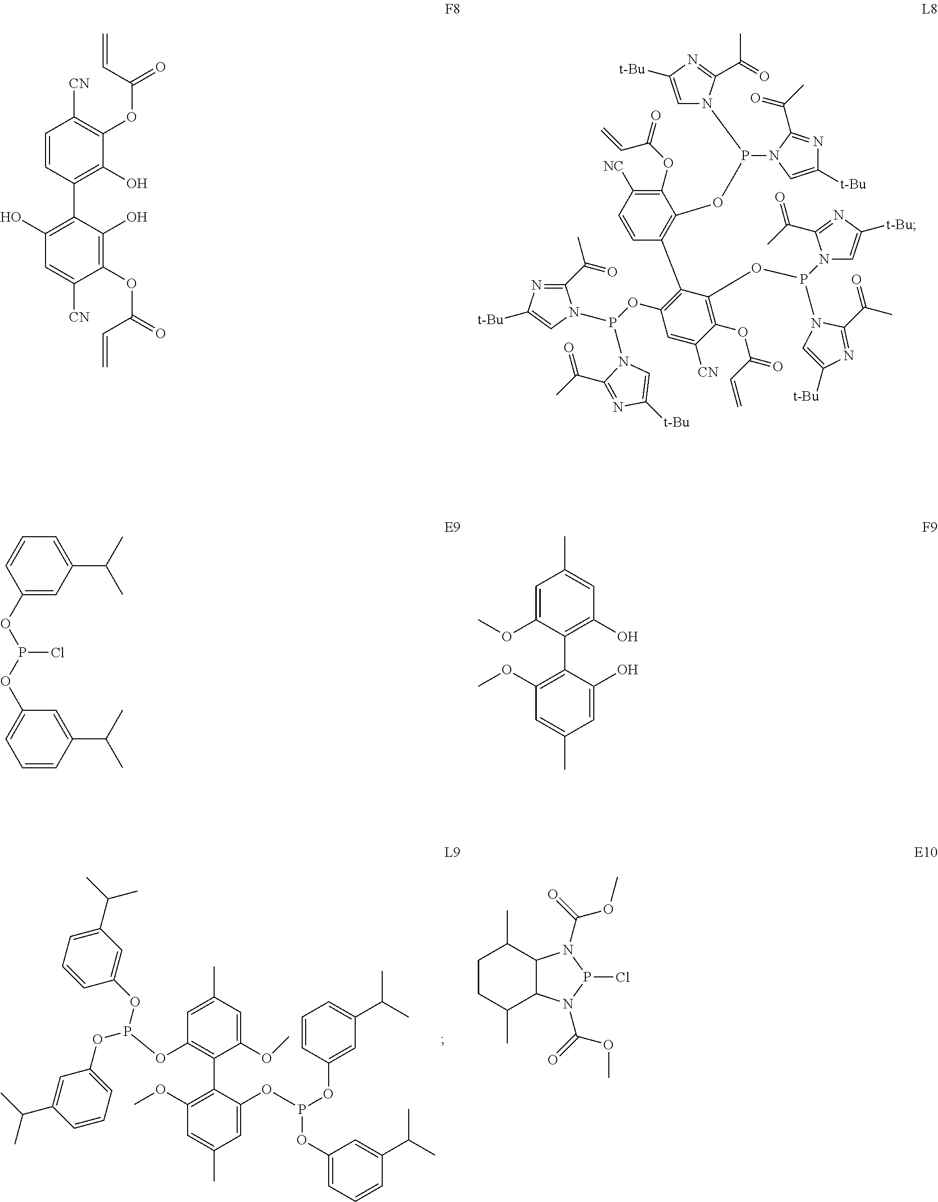 [SMILES: C=CC(=O)Oc1c(C#N)ccc(-c2c(O)cc(C#N)c(OC(=O)C=C)c2O)c1O ; C=CC(=O)Oc1c(C#N)ccc(-c2c(OP(n3cc(C(C)(C)C)nc3C(C)=O)n3cc(C(C)(C)C)nc3C(C)=O)cc(C#N)c(OC(=O)C=C)c2OP(n2cc(C(C)(C)C)nc2C(C)=O)n2cc(C(C)(C)C)nc2C(C)=O)c1OP(n1cc(C(C)(C)C)nc1C(C)=O)n1cc(C(C)(C)C)nc1C(C)=O ; CC(C)c1cccc(OP(Cl)Oc2cccc(C(C)C)c2)c1 ; COc1cc(C)cc(O)c1-c1c(O)cc(C)cc1OC ; COc1cc(C)cc(OP(Oc2cccc(C(C)C)c2)Oc2cccc(C(C)C)c2)c1-c1c(OC)cc(C)cc1OP(Oc1cccc(C(C)C)c1)Oc1cccc(C(C)C)c1 ; COC(=O)N1C2C(C)CCC(C)C2N(C(=O)OC)P1Cl]

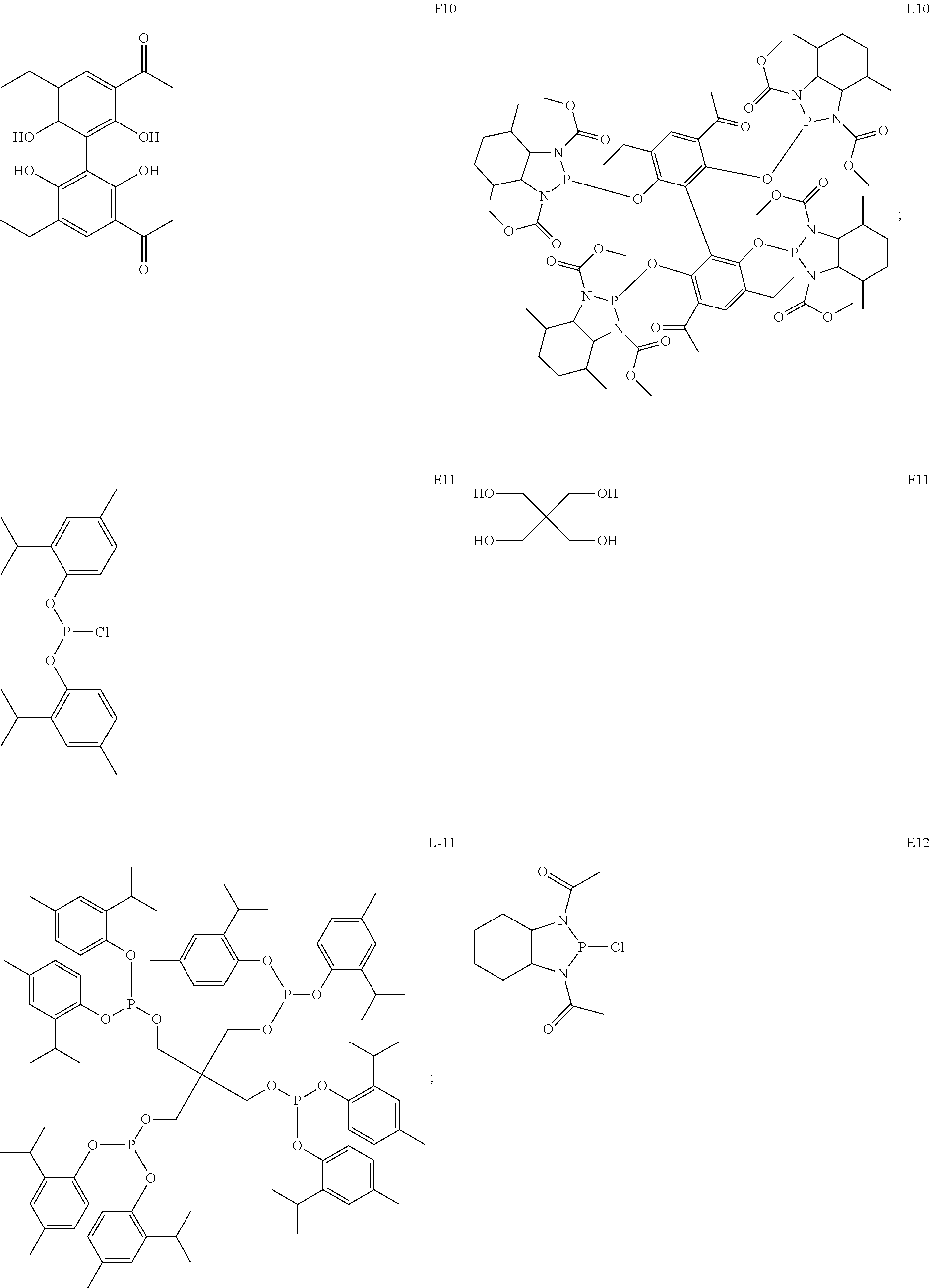 [SMILES: CCc1cc(C(C)=O)c(O)c(-c2c(O)c(CC)cc(C(C)=O)c2O)c1O ; CCc1cc(C(C)=O)c(OP2N(C(=O)OC)C3C(C)CCC(C)C3N2C(=O)OC)c(-c2c(OP3N(C(=O)OC)C4C(C)CCC(C)C4N3C(=O)OC)c(CC)cc(C(C)=O)c2OP2N(C(=O)OC)C3C(C)CCC(C)C3N2C(=O)OC)c1OP1N(C(=O)OC)C2C(C)CCC(C)C2N1C(=O)OC ; Cc1ccc(OP(Cl)Oc2ccc(C)cc2C(C)C)c(C(C)C)c1 ; OCC(CO)(CO)CO ; Cc1ccc(OP(OCC(COP(Oc2ccc(C)cc2C(C)C)Oc2ccc(C)cc2C(C)C)(COP(Oc2ccc(C)cc2C(C)C)Oc2ccc(C)cc2C(C)C)COP(Oc2ccc(C)cc2C(C)C)Oc2ccc(C)cc2C(C)C)Oc2ccc(C)cc2C(C)C)c(C(C)C)c1 ; CC(=O)N1C2CCCCC2N(C(C)=O)P1Cl]

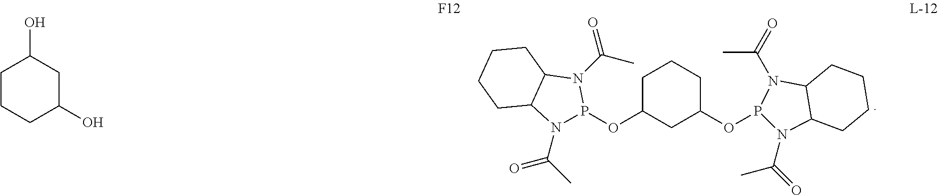 [SMILES: OC1CCCC(O)C1 ; CC(=O)N1C2CCCCC2N(C(C)=O)P1OC1CCCC(OP2N(C(C)=O)C3CCCCC3N2C(C)=O)C1]

### Embodiment 1

Phosphorus chloride compound E1 (86.17 g, 0.341 mol), polypyridine ionic liquid-loaded porous microspheres D1 (3.68 g, containing 0.0195 mol of nitrogen element), and toluene were mixed into 200 mL of a first mixture.

4, 5-dimethyl-2, 2′, 6, 6′-tetrahydroxybiphenyl F1 (20 g, 0.081 mol) was mixed with toluene to make 100 mL of a second mixture.

Dry nitrogen gas was continuously fed into a reaction device for 30 min to replace air and water vapor inside the reaction device. Then the first mixture was transferred to the reaction device, and the second mixture was transferred to a high-level dripping device. A stirrer in the reaction device was started and hydrogen chloride absorption system was operated.

At a temperature of 25 degrees centigrade, the second mixture was continuously and uniformly added into the reaction device from the high-level dripping device. An adding time was 3 hours, and dry nitrogen was continuously introduced into the reaction device during the dripping process. After the dripping process was completed, reactants in the reaction device were continuously stirred for 4 hours. Subsequently, a reaction solution was filtered to remove polypyridine ionic liquid-loaded porous microspheres D1 from the reaction solution to obtain a filter liquor. The filter liquor was concentrated to remove toluene from the filter liquor and obtain a concentrated solution. The concentrated solution was separated and purified by column chromatography to obtain 70.65 g of phosphorus-containing ligand L1 with a yield of 78.3%.

Methods for preparing phosphorus-containing ligands L2 to L12 were the same as the method for preparing the phosphorus-containing ligand L1, except that reaction parameters in the methods for preparing the phosphorus-containing ligands L2 to L12 were different from those in the method for preparing the phosphorus-containing ligand L1. Specific reaction parameters in the methods for preparing the phosphorus-containing ligands L2 to L12 were shown in Table 3, and reaction results thereof were shown in Table 4.

TABLE 3

| | Polypyridine | | Phosphorus | | | |
|---|---|---|---|---|---|---|
| | ionic liquid- | | chloride compounds | | Compound | |
| | loaded porous | | represented | | represented | |
| | microspheres | | in Formula (1) | | in Formula (2) | |
| | Type | Mass/g | Type | Mass/g | Type | Mass |
| Embodiment 1 | D1 | 3.68 | E1 | 86.17 | F1 | 20 |
| Embodiment 2 | D2 | 0.38 | E2 | 45.95 | F2 | 20 |
| Embodiment 3 | D3 | 1.98 | E3 | 91.33 | F3 | 20 |
| Embodiment 4 | D4 | 2.78 | E4 | 55.69 | F4 | 20 |
| Embodiment 5 | DS | 0.97 | E5 | 47.00 | F5 | 20 |
| Embodiment 6 | D6 | 3.73 | E6 | 138.40 | F6 | 20 |
| Embodiment 7 | D7 | 5.22 | E7 | 137.74 | F7 | 20 |
| Embodiment 8 | D8 | 1.37 | E8 | 69.80 | F8 | 20 |
| Embodiment 9 | D9 | 1.63 | E9 | 56.48 | F9 | 20 |
| Embodiment 10 | D10 | 3.68 | E10 | 86.45 | F10 | 20 |
| Embodiment 11 | D11 | 6.04 | E11 | 364.14 | F11 | 20 |
| Embodiment 12 | D12 | 0.69 | E12 | 262.06 | F12 | 20 |

TABLE 4

| | | | | | Recovery rate |
|---|---|---|---|---|---|
| | | | | | of polypyridine |
| | Phosphorus-containing ligand | | | | ionic liquid- |
| | | Mass/ | Selec- | | loaded porous |
| | Type | g | tivity % | Yield | microspheres |
| Embodiment 1 | L1 | 70.65 | 83.9 | 78.3% | 99.2% |
| Embodiment 2 | L2 | 51.65 | 92.4 | 89.3% | 99.5% |
| Embodiment 3 | L3 | 67.40 | 80.5 | 75.6% | 98.7% |
| Embodiment 4 | L4 | 42.74 | 71.3 | 65.8% | 99.1% |
| Embodiment 5 | L5 | 38.37 | 76.2 | 71.4% | 99.7% |
| Embodiment 6 | L6 | 80.38 | 65.8 | 61.5% | 98.9% |
| Embodiment 7 | L7 | 70.25 | 60.6 | 55.4% | 99.0% |
| Embodiment 8 | L8 | 48.22 | 70.5 | 64.2% | 99.6% |
| Embodiment 9 | L9 | 48.99 | 81.7 | 76.8% | 99.4% |
| Embodiment 10 | L10 | 60.49 | 75.3 | 72.1% | 98.8% |
| Embodiment 11 | L11 | 180.59 | 88.9 | 85.7% | 99.4% |
| Embodiment 12 | L12 | 87.63 | 93.5 | 89.5% | 99.1% |

### Experiments on Recycle of Polypyridine Ionic Liquid-Loaded Porous Microspheres

Polypyridine ionic liquid-loaded porous microspheres D1 recycled in Embodiment 1 were re-used in experiments for preparing phosphorus-containing ligand L1. Data of the experiments were shown in Table 5 below, and specific steps for preparing the phosphorus-containing ligand L1 were the same as those in Embodiment 1.

TABLE 5

| | Polypyridine ionic | | | | |
|---|---|---|---|---|---|
| | liquid-loaded porous | | | | |
| | microspheres D1 | | | Phosphorus- | |
| | content of | | | containing | |
| Times of | nitrogen | Recovery | Reaction | ligand L1 | |
| recycle | element/% | rate/% | time/h | Selectivity/% | Yield/% |
| 1 | 7.43 | 99.3 | 4 | 83.6 | 78.5 |
| 3 | 7.41 | 99.5 | 4 | 83.9 | 78.7 |
| 5 | 7.40 | 99.4 | 4 | 83.4 | 78.1 |
| 10 | 7.38 | 99.6 | 4 | 83.2 | 78.4 |
| 20 | 7.36 | 98.9 | 4 | 81.5 | 76.9 |

It can be seen from Table 5 that the polypyridine ionic liquid-loaded porous microspheres of the present disclosure can be recycled for many times, and a recovery rate was still greater than 95% and a reactivity was not significantly reduced after 20 recycles.

### Comparative Embodiment 1

Comparative embodiment 1 differed from Embodiment 1 only in that the polypyridine ionic liquid-loaded porous microspheres in embodiment 1 was replaced with a weak base type macroporous ion exchange resin (3.68 g, model: D301, produced by Chemical Plant of Nankai University). In comparative embodiment 1, after a reaction was completed, 48.45 g of phosphorus-containing ligand L1 was can be obtained by separation and purification, with a selectivity of 59.2% and a yield of 53.7%.

### Comparative Embodiment 2

Comparative embodiment 2 differed from Embodiment 1 only in that the polypyridine ionic liquid-loaded porous microspheres in Embodiment 1 was replaced with 81 mL of anhydrous triethylamine, and the reaction in comparative embodiment 2 was carried out without continuous introduction of dry nitrogen or operation of hydrogen chloride absorption system. In comparative embodiment 2, after the reaction was completed, 38.35 g of phosphate-containing ligand L1 was obtained by separation and purification, with a selectivity of 47.3% and a yield of 42.5%.

In preparation methods of the present disclosure, polypyridine ionic liquid-loaded porous microspheres were used as catalysts, and porous structures of the polypyridine ionic liquid-loaded porous microspheres can increase catalytic active sites of a reaction, thereby improving a selectivity and a yield of the reaction. Meanwhile, a catalytic effect can reduce an activation energy required for the reaction. Specifically, due to the catalytic effect, a reaction temperature can be reduced, and a chemical reaction rate can be speed up, which is more suitable for preparing phosphorus-containing ligands containing sensitive groups (such as double bonds, etc.). Moreover, the catalysts in the present disclosure have stable properties, simple post-treatments, good recycling performances, and thus they are easy to be recovered and reused.

In the present disclosure, in a reaction process, hydrogen chloride generated by the reaction is removed from a reaction device, so as to solve problems of a high viscosity of a system and a difficult post-processing, thus improving a selectivity and a yield of the reaction.

The technical features of the above-described embodiments may be combined in any combination. For the sake of brevity of description, not all possible combinations of the technical features in the above embodiments are described. However, as long as there is no contradiction between the combinations of these technical features, all should be considered as within the scope of this disclosure.

The above-described embodiments are merely illustrative of several embodiments of the present disclosure, and the description thereof is relatively specific and detailed, but is not to be construed as limiting the scope of the disclosure. It should be noted that a number of variations and modifications may be made by those skilled in the art without departing from the spirit and scope of the disclosure. Therefore, the scope of the disclosure should be determined by the appended claims.

1. A method for preparing a phosphorus-containing ligand, comprising:
mixing a phosphorus chloride compound as shown in Formula (1), first polypyridine ionic liquid-loaded porous microspheres with a first organic solvent to obtain a first mixture, and mixing a compound as shown in Formula (2) with a second organic solvent to obtain a second mixture; and
mixing the first mixture with the second mixture in a reaction device to make the first mixture react with the second mixture to obtain a reaction mixture, removing generated hydrogen chloride from the reaction device, filtrating the reaction mixture to obtain a filter liquor after a reaction of the first mixture and the second mixture, and treating the filter liquor to obtain the phosphorus-containing ligand, 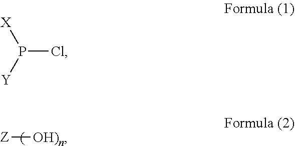
wherein in Formula (1), X and Y are independently selected from substituted aryloxy groups or nitrogen-containing heterocyclic groups,
in Formula (2), Z is a multivalent aliphatic hydrocarbon group or a multivalent aromatic hydrocarbon group comprising at least one substituent group,
wherein the at least one substituent group is selected from hydrogen atom, halogen atoms, C₁-C₁₀ alkyl group, C₁-C₁₀ alkoxy group, C₁-C₁₀ alkanoyl group, aryl group, heteroaryl group, cyano group, or nitro group, and n is an integer in a range of 1 to 8.

2. The method of claim 1, wherein the first polypyridine ionic liquid-loaded porous microspheres comprises a polypyridine ionic liquid, and a structural formula of the polypyridine ionic liquid is shown in Formula (3), 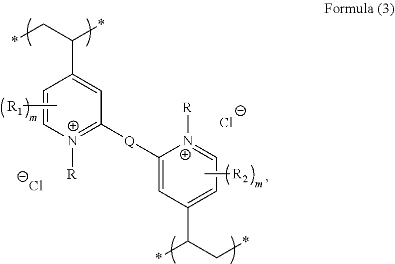
wherein in Formula (3), R is selected from a C₁-C₁₀ linear chain alkyl group or a C₁-C₁₀ branched chain alkyl group, wherein R₁ and R₂ are independently selected from hydrogen atom, halogen atoms, C₁-C₁₀ alkyl group, C₁-C₁₀ alkoxy group, C₁-C₁₀ alkanoyl group, aryl group, heteroaryl group, cyano group, or nitro group, m is an integer in a range of 0 to 3, and Q is a direct bond or a divalent linking group.

3. The method of claim 2, wherein Q is selected from 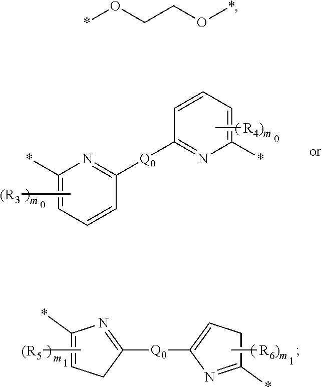
wherein R₃, R₄, R₅, and R₆ are independently selected from hydrogen atom, halogen atoms, C₁-C₁₀ alkyl group, C₁-C₁₀ alkoxy group, C₁-C₁₀ alkanoyl group, aryl group, heteroaryl group, cyano group, or nitro group, wherein Q₀ is selected from a direct bond or a divalent linking group, m₀ is an integer in a range of 0 to 3, and m₁ is an integer in a range of 0 to 2.

4. The method of claim 3, wherein Q₀ is selected from 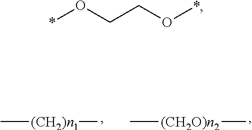
substituted aryl group, or unsubstituted aryl group, and n₁ and n₂ are independently selected from integers in a range of 1 to 50.

5. The method of claim 1, wherein the first polypyridine ionic liquid-loaded porous microspheres comprises polystyrene porous microspheres, particle sizes of the polystyrene microspheres are in a range of 50 nm to 100 nm, and a relative deviation of the particle sizes is less than 3%.

6. The method of claim 1, wherein a BET specific surface area of the first polypyridine ionic liquid-loaded porous microspheres is in a range of 50 m²/g to 500 m²/g, and an average aperture size of apertures in the first polypyridine ionic liquid-loaded porous microspheres is in a range of 10 nm to 50 nm.

7. The method of claim 1, wherein in Formula (1), a structural formula of the substituted arylxy groups is 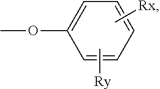
wherein Rx and Ry are independently selected from hydrogen atom, halogen atoms, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

8. The method of claim 7, wherein when both X and Y are selected from 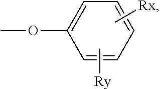
X and Y are not cyclized; or,
when both X and Y are selected from nitrogen-containing heterocyclic groups, X and Y are not cyclized, or X and Y are cyclized via a single bond or methylene; or,
when X is selected from 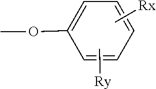
and Y is selected from nitrogen-containing heterocyclic groups, X and Y are cyclized via methylene.

9. The method of claim 8, wherein the nitrogen-containing heterocyclic groups are selected from 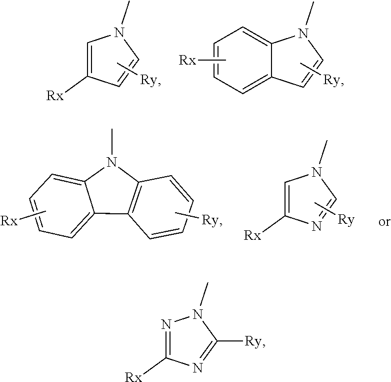
wherein Rx and Ry are independently selected from hydrogen atom, halogen atoms, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group or methacryloyl group.

10. The method of claim 9, wherein both X and Y are selected from nitrogen-containing heterocyclic groups, and X and Y are cyclized via the single bond or the methylene to form a structure selected from any one of the group consisting of

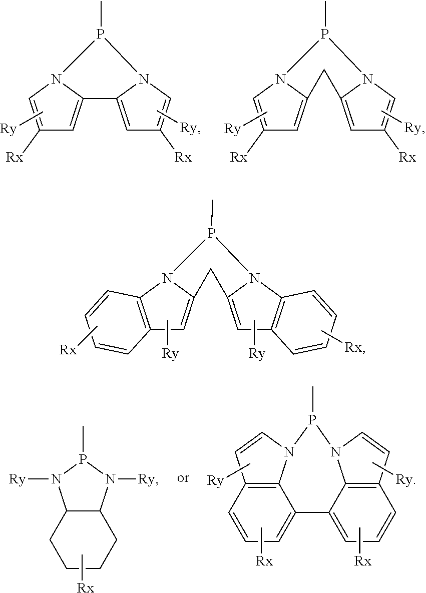

11. The method of claim 1, wherein in Formula (2), Z is selected from 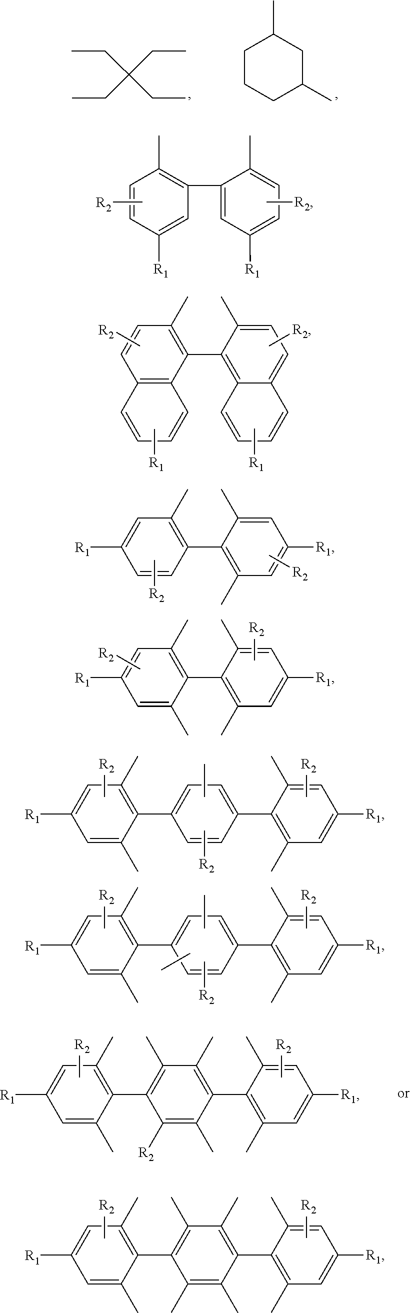
wherein R₁ and R₂ are independently selected from hydrogen atom, halogen atoms, nitrile group, C₁-C₁₀ alkyl group, C₁-C₁₀ alkoxy group, C₁-C₁₀ alkanoyl group, C₁-C₁₀ ester group, C₁-C₁₀ sulfonate group, vinyl group, propenyl group, acryloyl group, acrylate group, or methacryloyl group.

12. The method of claim 1, wherein in Formula (2), n is an integer in a range of 2 to 4.

13. The method of claim 1, wherein in the step of mixing the first mixture with the second mixture in the reaction device to obtain the reaction mixture, a molar ratio of the phosphorus chloride compound to the compound as shown in Formula (2) is in a range of 1.0:(1/x) to 1.3:(1/x), x is equal to n in Formula (2), and a molar ratio of nitrogen atoms in the first polypyridine ionic liquid-loaded porous microspheres to hydroxyl groups in the compound as shown in Formula (2) is in a range of 0.01:1 to 0.1:1.

14. The method of claim 13, wherein a molar concentration of the phosphorus chloride compound in the first mixture is in a range of 0.05 mol/L to 5.0 mol/L, and a molar concentration of the compound as shown in Formula (2) in the second mixture is in a range of 0.05 mol/L to 5.0 mol/L.

15. The method of claim 1, wherein in the step of mixing the first mixture with the second mixture in the reaction device to make the first mixture react with the second mixture to obtain the reaction mixture, a reaction temperature is in a range of 0 to 50 degrees centigrade, and a reaction time is in a range of 1 hour to 5 hours.

16. The method of claim 1, wherein in the step of mixing the first mixture with the second mixture in the reaction device to make the first mixture react with the second mixture to obtain the reaction mixture, adding the second mixture into the first mixture in batches.

17. The method of claim 16, wherein in the step of adding the second mixture into the first mixture in batches, an adding duration is in a range of 2 hours to 10 hours.

18. The method of claim 1, wherein the step of filtrating the reaction mixture to obtain the filter liquor after the reaction further comprises recovering second polypyridine ionic liquid-loaded porous microspheres.

19. The method of claim 18, wherein after the recovering the second polypyridine ionic liquid-loaded porous microspheres, further comprising a step of washing, drying and re-using the recovered second polypyridine ionic liquid-loaded porous microspheres for preparing the first mixture.

20. The method of claim 1, wherein the step of mixing the first mixture with the second mixture in the reaction device to make the first mixture react with the second mixture to obtain the reaction mixture further comprises blowing a protective gas in to the reaction device to remove the generated hydrogen chloride out from the reaction device.
